(19) United States
(12) Patent Application Publication
(10) Pub. No.: US 2007/0062401 A1
(43) Pub. Date: Mar. 22, 2007

(54) Customized Carbon Paper and Method for Making the Same

(76) Inventor: Swee Guan Chee, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/556,703

(22) Filed: Nov. 6, 2006

Related U.S. Application Data
(62) Division of application No. 10/875,148, filed on Jun. 22, 2004.

(51) Int. Cl. B05D 5/00; B41F 33/00

(52) U.S. Cl. 101/483; 427/256

(57) ABSTRACT

A media sheet having a customized carbon paper portion thereon and a method for making the same are disclosed. The media sheet having a first and second side, the first side of the media sheet comprising a carbon paper portion, the carbon paper portion being capable of transferring a marking onto a surface capable of receiving the marking, the marking corresponds to a pressure applied to the second side of the media sheet over the carbon paper portion.

### CROSS-REFERENCE TO RELATED APPLICATIONS

This application is a divisional of application Ser. No. 10/875,148, filed Jun. 22, 2004, hereby incorporated by reference.

### FIELD OF INVENTION

The present invention relates generally to tracing papers. More particularly, the present invention relates to a media sheet having a customized carbon paper portion thereon and a method for making the same.

### BACKGROUND OF INVENTION

Carbon paper has been in use for sometime. Carbon paper typically comes in a sheet form which has readily transferable ink on one side. Prior to the influx of home and office equipment such as photocopiers and printers, carbon paper was a popular and convenient way for making multiple copies of a document using a mechanical type-writer. Today, carbon paper is less widely used due to its lack of cleanliness and relatively poor output quality. As such, carbon paper is frequently used where there is a need for quick duplication purposes such as making hand-written payment receipts or recording serial numbers of tickets and the like duplication needs.

The concept of carbon paper is still relevant in today's society. However, it can be cumbersome to keep re-inserting the carbon paper between a master sheet and a copy sheet. Further, in some instances, it can be impractical to have a sheet of carbon paper inserted between two sheets of paper when only a small portion of duplication area, such as for duplicating serial numbers or signatures, are needed.

Therefore, it is desirable to provide a media sheet having a customized carbon paper portion thereon.

### SUMMARY OF INVENTION

The present invention provides a media sheet having a customized carbon paper portion thereon. The first side of the media sheet includes a carbon paper portion. The carbon paper portion is capable of transferring a marking onto a surface capable of receiving the marking. The marking corresponds to a pressure applied to the second side of the media sheet over the carbon paper portion.

The present invention also provides a method for making the media sheeting having a customized carbon paper portion thereon. The method includes providing a media sheet, specifying a carbon paper portion on the media sheet, and applying ink to the specified carbon paper portion

### BRIEF DESCRIPTION OF DRAWINGS

Embodiments of the invention are herein described, purely by way of example, with reference to the accompanying drawings, in which:

FIG. 1 shows a document having a customized carbon paper portion thereon according to an embodiment of the present invention;

FIG. 2 shows a stacked document illustrating the application of the document of FIG. 1; and

FIG. 3 shows a flowchart of a method for creating the document of FIG. 1 in accordance with an embodiment of the present invention.

### DETAILED DESCRIPTION OF INVENTION

A media sheet having a customized carbon paper portion thereon and a method for making the same are described hereinafter with reference to the drawings. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

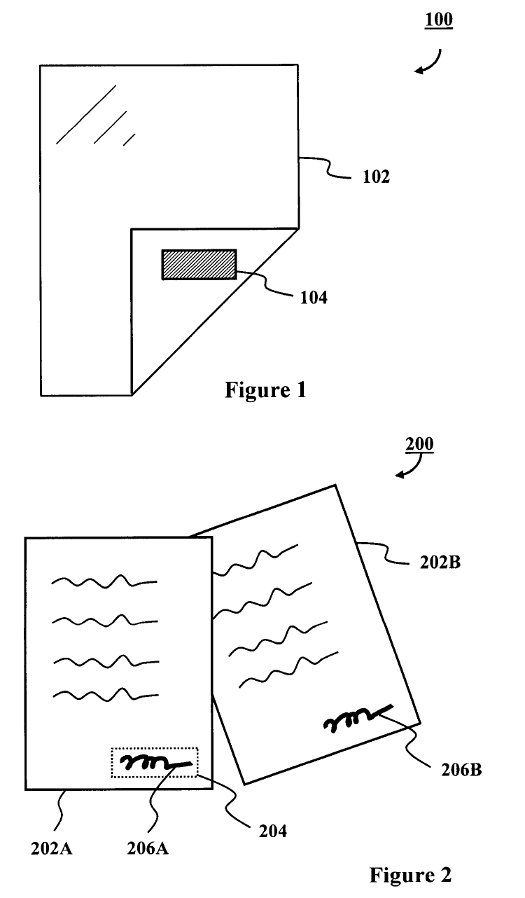

According to an embodiment, a document 100 including a media sheet 102 (e.g. a paper) can be produced with a customized carbon paper portion 104 thereon as shown in FIG. 1. The customized carbon paper portion 104 is located at a position on the side of the media sheet 102 which is directly opposite to a customized position where duplication is required. As illustrated in FIG. 1, the customized position is located at the bottom right hand side of the media sheet 102, a portion typically reserved for signatures and the like markings.

The customized carbon paper portion 104 is made of ink applied on the media sheet 102 at the desired location. In an embodiment, the ink is a pigment based ink printed on the media sheet 102 using an inkjet printer. The pigment based ink is commonly found in inkjet printers. The pigment based ink provides good mark transfer effect because substantial portion of the ink resides on the surface of the media sheet 102 upon application thereto.

In another embodiment, a dye based ink can be printed on the media sheet 102 using an inkjet printer to create the customized carbon paper portion 104. The dye based ink is commonly found in color inkjet printers, wherein the dye based ink provides a wide range of color gamut. The dye based ink has the tendency to permeate deep into the media sheet 102. Thus, an underlay coat can be applied to the desired location prior to applying the dye based ink to trap more ink at the surface of the media sheet 102 to provide superior mark transfer effect.

An exemplary application of a media sheet having a customized carbon paper portion thereon is shown in FIG. 2. FIG. 2 shows a stacked document 200 including original sheets 202A and 202B, both of which are duplicate printed sheets having the same content, font, and layout. Such duplicate printed sheets are commonly used for official letters, legal agreements, or the like official documents. By providing a customized carbon paper portion 204 on the underside of the original sheet 202A, the marking of a signature 206A (or the like markings) on the topside of the original sheet 206A at the location 204 is transferred to the topside of the original sheet 202B thereby providing a signature 206B which is an exact copy of the signature 206A. In this way, signatures or similar markings are only needed to be applied once to the first sheet of the stacked document 200. Thus, customized carbon paper portion 204 eliminates the need for applying multiple signatures, which are most likely to be a variation of each other, to the stacked document 200 where accuracy and consistency are required.

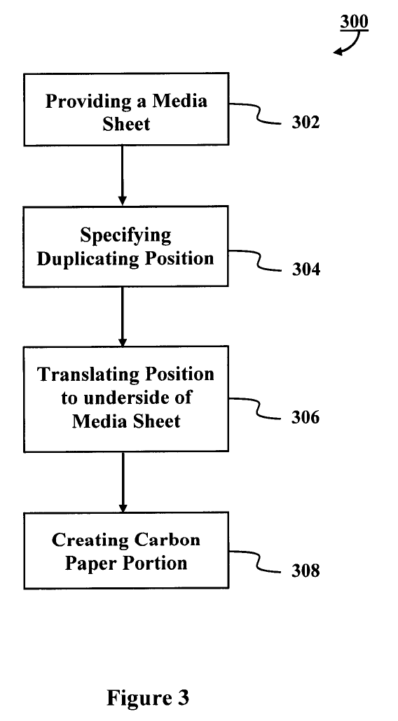

A flowchart 300 of a method for making the media sheet having a customized carbon paper portion 104 thereon as shown in FIG. 1 is described hereinafter with reference to FIG. 3. The steps of flowchart 300 are described in accordance with an embodiment where an inkjet printer is used for creating the customized carbon paper portion 104 on the media sheet 102. In a step 302, a media sheet 102 having a topside for printing document content and an underside for creating the customized carbon paper portion is provided. A portion on the topside of the media sheet 102 requiring duplicating is specified in a step 304. In an embodiment, the portion on the topside of the media sheet 102 may be specified by providing positional coordinates for defining the area of the carbon paper portion.

In another embodiment, the portion requiring duplicating on the topside of the media sheet 102 may be specified by drawing a non-printable or watermark shape (e.g. a rectangle or an oval) and positioning the shape at the portion on the topside of the media sheet 102 where duplication is desired. Such specifying method can by performed by using a customized drawing mode wherein the shapes and drawing tools similar to those commonly provided in modern word processor applications can be employed.

Once the duplicating portion on the topside of the media sheet 102 is specified in the step 304, the customized carbon paper portion is created in a step 308. However, in an embodiment, prior to applying the ink on the underside of the media sheet 102, the position of the specified shape on the topside of the media sheet 102 is translated to a corresponding portion on the underside of the media sheet 102 in a step 306. Translating the corresponding position of the specified shape from the topside to the underside of the media sheet 102 is known and any number of ways can be used to perform this task for the purpose of the embodiment.

In an alternative embodiment, step 306 of the flowchart 300 may not be needed. In this case, the side of the media sheet upon which the duplicating position is specified in the step 304 is the actual side where the carbon paper portion is to be created.

Once the position of the specified shape on the underside of the media sheet 102 is determined, the duplicating portion or shape specified in the step 304 is printed by the inkjet printer to create the customized carbon paper portion in a step 308. In the step 308, if the inkjet printer is a duplex printer, the content of the document and the customized carbon paper portion can be respectively printed on the topside and underside of the media sheet 102 in one continuous action. This is achieved by first printing the content of the document on the topside and automatically flipping the media sheet 102 to print the customized carbon paper portion on the underside thereof. The output from step 308 is a media sheet 102 having a customized carbon paper portion on the underside of the media sheet 102.

In the step 308, if the ink used is a dye based ink, an underlay coat having the specified shape can be applied prior to applying the dye based ink. Alternatively, the underside of the media sheet 102 can be provided with a pre-coated underlay for trapping the dye based ink at the surface of the media sheet. In yet another alternative, the underside of the media sheet 102 can be pre-treated with a chemical capable of trapping the dye based ink at the surface of the media sheet 102.

In the foregoing, embodiments of the invention are described with reference to FIGS. 1-3. It is anticipated that individuals skilled in the art may make other modifications and equivalents thereto. For example, more than one customized carbon paper portions can be created at different locations on the media sheet. Therefore, the foregoing description should not be taken as limiting the scope of the invention which is defined by the appended claims.

1. A method for making a media sheet having a customized carbon paper portion thereon, the method comprising the steps of:
providing a media sheet;
specifying a carbon paper portion on the media sheet; and
using an inkjet printer to print a dye-based ink at the specified carbon paper portion of the media sheet to create the customized carbon paper portion thereon, wherein said customized carbon paper portion is capable of transferring a marking onto a surface.

2. The method of claim 1, wherein the step of specifying the carbon paper portion comprises the step of providing positional coordinates for defining the area of the carbon paper portion.

3. The method of claim 1, wherein the step of specifying the carbon paper portion comprises the step of providing a non-printable or watermark shape at a location on the media sheet.

4. A method for making a media sheet having a customized carbon paper portion thereon, the method comprising the steps of:
providing a media sheet having first and second sides;
specifying a carbon paper portion on the first side of the media sheet;
translating the specified carbon portion from the first side to the second side of the media sheet; and
using an inkjet printer to print a dye-based ink to the specified carbon paper portion on the second side of the media sheet,
wherein said customized carbon paper portion is capable of transferring a marking onto a surface.

5. The method of claim 4, wherein the step of specifying the carbon paper portion comprises the step of providing positional coordinates for defining the area of the carbon paper portion.

6. The method of claim 5, wherein the step of specifying the carbon paper portion comprises the step of providing a non-printable or watermark shape at a location on the first side of the media sheet.

7. The method of claim 4 further comprising the step of applying an underlay coat on the second side of the media sheet prior to the step of printing ink.

8. The method of claim 4, wherein the step of providing the media sheet comprises the step of providing a media sheet having the second side thereof being pre-treated with a chemical capable of trapping the ink at the surface of the media sheet.

9. The method of claim 4 further comprising the step of printing the content of a document on the first side of the media sheet using said inkjet printer.
